(19) United States
(12) Patent Application Publication
(10) Pub. No.: US 2018/0245846 A1
(43) Pub. Date: Aug. 30, 2018

(54) DEVICE FOR CONTROLLED VENTILATION AND CURING PROCESSES

(71) Applicant: BASF Coatings GMBH, Muenster (DE)

(72) Inventors: Christian Arens, Muenster (DE); Rene Waeltermann, Drensteinfurt (DE); Marc Daniel, Muenster (DE)

(21) Appl. No.: 15/553,023

(22) PCT Filed: Feb. 24, 2016
(86) PCT No.: PCT/EP2016/053830

§ 371 Date: Aug. 23, 2017

(30) Foreign Application Priority Data
Feb. 26, 2015 (EP) 15156757.5

(51) Int. Cl. F26B 3/30; F26B 3/28; F26B 21/00; B05D 3/04; B05D 5/00

(52) U.S. Cl. CPC F26B 3/30; F26B 3/283; F26B 21/004; F26B 2210/12; B05D 3/0426; B05D 5/005; B05D 3/0413

(57) ABSTRACT

Provided herein is a portable apparatus for controlled venting and curing operations on coating materials through combination of infrared radiation with cold and/or hot turbulent airflows for the purpose of setting optimum conditions during the venting and curing of coating materials in repair coatings.

The invention relates to portable apparatus for controlled venting and curing operations on coating materials through combination of infrared radiation with cold and/or hot turbulent airflows for the purpose of setting optimum conditions during the venting and curing of coating materials in repair coatings.

### PRIOR ART

Extremely exacting requirements are nowadays imposed on the repair coating, or refinishing, of vehicles. Hence the finishing outcome is to be comparable, visually and technologically, with a baked original finish, despite key differences in the attendant conditions.

Unlike coating materials from OEM finishing, refinish coating materials cure at substantially lower temperatures. This is necessary because there can be no baking of the coating materials on the articles. Article temperatures of 80° C. must not be exceeded, since otherwise there may be damage, such as the melting of plastics parts, the deformation of tires, and irreversible damage to the electrics.

On account of the great diversity of shades that occur, but also because of the multitude of fields of use, there is an extensive product palette of different coating materials for implementing repair coatings. The extensive product palette allows optimum adaptation of the repair coating to the original finish. In order to obtain an optimum outcome in terms of the visual and technological quality of the coating, however, there should always be adaptation of the venting and curing conditions to the specific properties of the coating material.

It is known that the curing of repair coating materials is performed primarily by moving infrared emitters. In this case, the coating material is cured by means of radiation in the infrared range. This radiation is absorbed by the applied coating material and converted into thermal energy through vibratory excitation. The substrate and the coating material become heated, and the coating material is dried from the inside out. EP 1 854 552 A1 discloses an operation for the curing of coating materials in the refinishing of vehicles, using infrared radiation alone.

It is known, furthermore, that the coating material applied to an article is flashed off, or vented, prior to curing, in order to obtain high quality on the part of the coating. In the course of venting, convection techniques are employed which are based on the generation of cold and/or hot airflows. Venting is carried out using what are called dry jets or Venturi systems. These are fed with unheated compressed air and are directed onto the coating material applied to a substrate, with the objective of removing a large part of the solvent, so that the coating material does not develop blisters in the course of the subsequent curing. Utility model specification DE 202 21 848 U1 describes a drying accessory for the generation of turbulent airflows for painting and drying installations for the venting and curing of paint finishes on vehicles and vehicle parts. It provides for an airflow to be directed against the vehicle via the filter cover of a closed booth housing, and to be drawn off again at the bottom. The high airflow velocities and intensities are obtained by drawing in air via an additional fan, from a pressure compartment between booth ceiling and filter cover, and transporting it to the air nozzles via an incoming-air duct system.

In the OEM finishing of automobile bodies, there are known operations in which convection techniques and radiation techniques are combined with one another in order to carry out venting and curing work. Combination of the two techniques leads to a considerable saving in time and costs. These operations are carried out in booths having both elements for generating airflows and infrared radiation sources. Operations in which the two techniques are combined with one another are disclosed in US 2003/0104133 A1, WO 2004/043616 A1, WO 2005/023437 A2, WO 00/72978 A2, WO 00/72979 A2 and WO 00/72980 A2.

The sheer infinite number of coating materials which are used in refinishing for very precise adaptation to the original finish poses a technical challenge for many repair workshops. In order to obtain an outcome that is optimum in terms of resistance and surface quality, it is important in repair workshops in particular that the venting and drying conditions can be adapted especially well to the specific properties of the coating material. Oftentimes, however, universal devices are used, which do not allow the venting and curing conditions to be monitored and hence do not allow them to be regulated either. An optimum outcome in terms of visual and technological properties is achieved, however, only if the venting and curing conditions can be adapted optimally to the various coating materials.

### Problem

The problem addressed by the invention is that of providing apparatus for implementing controlled venting and curing operations on coating materials for refinishing enterprises.

### Solution

This problem is solved by mobile apparatus having one or more infrared radiation sources and comprising an integrated accessory for generating cold and/or hot turbulent airflows. Controlled venting and curing conditions are achieved through serial or parallel connection of infrared radiation and turbulent airflows, allowing a venting and curing procedure to be carried out that is adapted individually to the respective coating material. Preferably there is thermal monitoring of the surface temperature as well, in order to ensure even better control and regulation conditions.

The aforementioned apparatus is referred to below as apparatus of the invention. Preferred embodiments of the apparatus of the invention are evident from the dependent claims and also from the description further on below.

A further subject of the invention is a method for partly or wholly removing solvents from a coating material applied to a substrate, using the apparatus of the invention.

A further subject of the invention is the use of the apparatus of the invention in the area of the repair coating of vehicles.

The appended drawings serve for further elucidation of the invention.

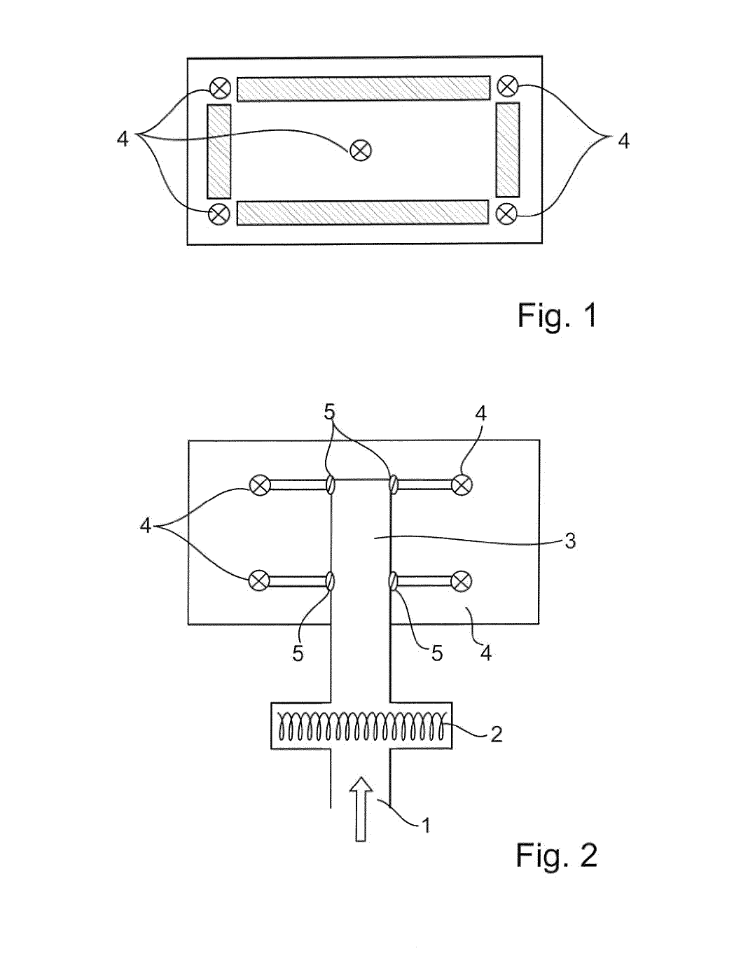

FIG. 1 shows a possible arrangement of the infrared radiation source(s) and of the blowing nozzle(s) (4) on the facing side of the apparatus of the invention. The term “facing side” here denotes the side that is facing the article to be dried during the venting and/or curing operation.

FIG. 2 shows a possible arrangement of a compressed air supply (1), of a regulatable heating element (2), of an incoming-air distributor system (3), of a plurality of blowing nozzles (4), and of a plurality of shutoff devices (5) on the reverse of the apparatus of the invention. The term “reverse” here denotes the side facing away from the article to be dried during the venting and/or curing operation.

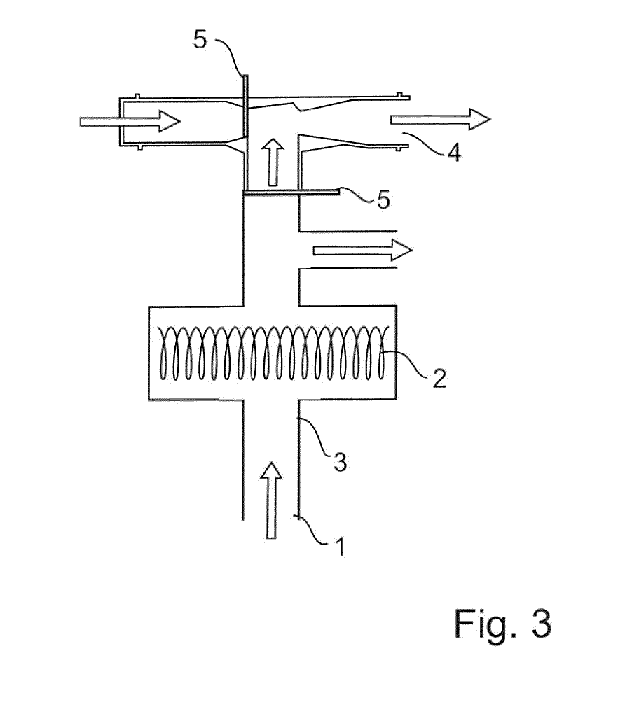

FIG. 3 shows the diagrammatic construction of a venturi nozzle.

The apparatus of the invention allows a controlled venting and curing operation and a regulation of the venting and curing conditions through the combination of infrared radiation sources with a device for generating turbulent airflows. The individual components can be harmonized with one another in such a way that optimum venting and curing conditions result for all coating materials used in the field of refinishes, with the apparatus of the invention.

Venting and curing conditions adapted individually to a particular coating material can be ensured through serial and/or parallel connection of infrared radiation and turbulent airflows.

In the case of serial connection, in other words the successive use of infrared radiation and of turbulent airflows, or vice versa, it is possible, for example, to carry out the overall operation in a plurality of steps: first of all the solvent present in a coating material is removed by turbulent airflows, curing is carried out with infrared radiation, and then turbulent airflows are used again to cool the cured coating.

In the case of a parallel connection it is possible, for example, to avoid overheating when using infrared radiation, by the additional blowing of cold, turbulent airflows onto the coating material that is to be cured. It is also possible, for example, to use a combination of relatively low radiant intensity of the infrared radiation with slightly heated turbulent airflows.

The simultaneous application of infrared radiation with turbulent airflows has the additional advantage that there is no accumulation of solvent vapors at the surface of the coating material. The vapors emerging from the solvent are transported away by the turbulent airflow.

Another advantage of the portable apparatus is that its portable nature means that optimum venting and curing conditions can be ensured even at surfaces that are difficult to access. In the case of nonportable apparatus, the problem exists that surfaces that are difficult to access are not optimally covered by the infrared radiation and/or by the airflows. This may considerably influence the quality of the resulting coating.

Another advantage of the portable embodiment is that a very quick change to the venting and curing conditions can be implemented, through the possibility of altering the distance between the apparatus of the invention and the coating material to be dried.

Thermal monitoring of the venting and curing operation is accomplished preferably through measurement of the surface temperature of the coating material applied to the substrate. This ensures constant monitoring of the venting and curing conditions throughout the operation, and provides the possibility for correction or adjustment to the operating conditions.

An additional advantage arising through the use of the apparatus of the invention is a distinct reduction in the time for the implementation of venting and curing operations in the context of repair coatings.

To start with a number of terms used in the context of the present invention should be explained.

In the context of the present invention, the term “coating material” should be understood in accordance with DIN EN ISO 4618 (March 2007). The present invention relates in particular to products in liquid or paste form which, when applied to a substrate, produce a coating having protective, decorative and/or other specific properties.

The term “portable” should be understood in the context of the apparatus of the invention as mobile and not tied to a fixed location. As a preferred embodiment, the apparatus is mounted on rollers and is thereby movable.

Infrared drying designates the drying of coating materials by means of infrared radiation (IR radiation). The radiation striking an article is reflected, absorbed, and transmitted in dependence on the substrate, the shade, the resin and the film thickness of the coating material, the wavelength of the incident radiation, etc. The absorbed fraction is largely converted into heat, and is used for the heating of the coating material. “Infrared emitter” is the term for radiation sources with electromagnetic radiation in the wavelength range from 780 nm to about 1 mm that are used in infrared drying. The intensity is dependent on the wavelength spectrum. Depending on wavelength, emitters are classed as longwave (4 μm to 1 mm; technically achievable specific power up to 20 kW/m²), medium-wave (2 to 4 μm, 8 to 50 kW/m²), or shortwave (0.78 to 2 μm, 20 to 100 kW/m²) (Römpp Lexikon, Lacke and Druckfarben, Thieme Verlag, 1998, page 302).

The term “air turbulence” or “turbulent airflow” designates an airflow for which, in contrast to laminar flow, there is no uniform and directed movement, the average flow instead being superimposed with irregular fluctuations in velocity and pressure that are manifested in the form of eddies (Römpp Chemie Lexikon, Thieme Verlag, 9th, expanded edition, 1995).

For the purposes of the present invention, the term “vehicle” should be understood to refer to a construction with independent or external drive that is equipped with wheels, runners, or aerofoils and is intended for the conveying of people or loads. The vehicle is preferably a motor vehicle, which is a motor-driven vehicle not confined to rails.

Repair coating or refinishing is generally carried out, unlike OEM finishing, in repair enterprises using manual labor. The basic process of refinishing is guided by the cause of the repair (accident or sales finish), by the requirements in terms of the quality of the finish, and by the substrate. The repair coating is subject to the same requirements in terms of technological properties as is the OEM finish, meaning that high levels of resistance to weathering effects, to chemicals, and to mechanical exposure are expected. A further factor is that the curing of the refinish paints must take place at relatively low temperatures, specifically at article temperatures of not more than 60 to 80° C., since otherwise there is excessive harm to parts on the vehicle made from plastic and rubber (Römpp Lexikon Lacke and Druckfarben, Thieme Verlag, 1998). For the large number of different types of paint on the vehicles, moreover, exactly the right coating material must be found. In the automobile segment specifically, the repair of minor damage, also called spot repair, is often employed for the local repair of defects in the coating.

Venting, or flashing, refers to the partial or complete evaporation of the volatile fraction of a coating material, before film formation is complete and/or before a further coating material is applied.

Drying or curing refers to the whole complex of operations, reactions, conversions, etc. that accompany the transition of the coating material, applied in liquid form, to a solid film adhering thoroughly to the substrate. The result of the curing is a crosslinked film. This can be achieved through chemical or physical crosslinking, i.e., the interlooping of polymer chains by complete removal of the solvent.

The apparatus of the invention has one or more infrared radiation sources. Preference is given to using portable infrared emitters, of the kind known from the motor vehicle refinishing segment. The wavelength of the radiation used is situated in the infrared region. Wavelengths between 0.8 μm and 4 μm are used with preference.

The accessory for generating cold and/or hot turbulent airflows is mounted on the apparatus which comprises the infrared radiation source(s), and is understood accordingly as integrated. Components of this integrated accessory include a compressed air supply (1), a regulatable heating element (2), an incoming-air distributor system (3), one or more blowing nozzles (4), and one or more shutoff devices (5). The blowing nozzle(s) (4) here is/are mounted adjacent to the infrared radiation source(s), meaning that the radiation emitted by the radiation source(s), and the cold and/or hot turbulent airflows emitted by the blowing nozzle(s), can be directed simultaneously onto the article that is to be dried.

The compressed air supply (1) has a construction such that it is configured with maximum flexibility and mobility and is able to follow the changes in location of the drying equipment. For the apparatus of the invention, it is possible with preference to employ a compressed air supply which is present in repair workshops, as is used for the spray application of coating materials, for example.

The regulatable heating element (2) of the apparatus of the invention allows the temperature of the turbulent airflows emerging from the blowing nozzles (4) to be adjusted. The regulatable heating element (2) preferably allows stepless adjustment of the temperature of the turbulent air current in a temperature range from 20° C. (ambient temperature) to 120° C. (for short durations). With particular preference the temperature is adjustable within a range from 20° C. to 80° C. The upper temperature limit of 120° C. that is given here relates to the temperature of the turbulent airflows emerging from the blowing nozzles (4). As a result of loss of heat to the environment, the resulting article temperatures are about 80° C.

Heating element (2) used is preferably an electrical heating element, such as a heating coil or a self-regulating heating element made from cold conductors, for example.

The regulatable heating element (2) is used in order to generate hot air turbulences. In this context, the term “hot” refers to temperatures above the ambient temperature, of up to 120° C. The term “cold” refers to temperatures below the ambient temperature.

The incoming-air distributor system (3) is a duct system which joins the compressed air supply to one or more blowing nozzles (4). The incoming-air distributor system (3) is preferably a sealed duct system. With particular preference it is possible to realize pressures of 2 bar up to 10 bar in the sealed duct system, and the blowing nozzles (4) are mounted at the outlets of the duct system.

With regard to the one or more blowing nozzles (4), they preferably
d1) are able to operate on the Venturi principle and
d2) can be separated from the incoming-air distributor system (3) alternatively individually, in groups, or in their entirety, by means of shutoff devices (5), and
d3) are mounted such that the flow angle of the emergent turbulent airflow can be adapted individually or in groups to the article that is to be dried, and
d4) permit stepless regulation of the flow velocity of the emergent turbulent airflow,
d5) and the infrared radiation source(s) are mounted alongside one another but do not impair one another in their function.

In the present case, impairment between one another is to be avoided. This means that the blowing nozzle(s) (4) and the infrared radiation source(s) are mounted in such a way that there is no functional impairment of the individual components. Such impairment includes, for example, the affixing of the blowing nozzle(s) (4) in such a way that some of the infrared radiation given off from the infrared radiation source(s) is hidden by the blowing nozzle(s) (4).

For the application of the Venturi principle, the one or more blowing nozzles (4) must possess a constriction through which compressed air flows. As the compressed air flows through, an underpressure comes about at the narrowest point. Through the opening of a shutoff device (5), which is mounted at the narrowest point of the blowing nozzle (4) and cuts it off from the ambient air, the underpressure additionally causes inward suction of ambient air in order to relieve the compressed-air reservoir of the compressed air supply. The Venturi principle is employed in the generation of cold air turbulences.

In one particularly preferred embodiment, the one or more blowing nozzles (4) are affixed via swivelable joints for the purpose of setting the flow angle of the emergent turbulent airflow.

The shutoff device(s) (5) are also capable of cutting off one or more blowing nozzles (4) from the incoming-air distributor system (3), or of constricting them by partial closing, and hence for interrupting or reducing the turbulent airflows from the respective blowing nozzle (4), respectively. Preferred shutoff devices (5) are electronically regulatable actuators for fluid materials. Used with particular preference are valves, sliders, taps, and flaps. Used with very particular preference on account of their accessibility are valves and flaps.

The present invention further comprises a method for at least partly removing solvents from coating material applied to a substrate, where an apparatus of the invention is used. The preferred objective of the method is the complete removal of solvents from an applied coating material and hence the production of a coating.

With preference it is possible for the temperature of the coating material surface to be monitored continuously. With particular preference the temperature is measured by a contactless measuring method, such as by an infrared thermometer, for example.

This temperature measurement may be carried out manually by staff, who may where appropriate perform corresponding adaptation of the venting and curing conditions. In one especially preferred embodiment of the apparatus of the invention, there is coupling of the temperature measuring unit with the control of the infrared radiation sources and with the device for generating the turbulent airflows, allowing automated regulation according to a predefined operating sequence.

In another preferred embodiment of the method, the flow velocities of the emergent turbulent airflows are between 15 and 100 m/sec, more preferably between 15 and 50 m/sec, and very preferably between 15 and 30 m/sec.

The present invention further comprises the use of the apparatus of the invention in the area of the repair coating of vehicles.

One preferred use is represented by the implementation of venting and curing operations on coating materials in the repair coating of motor vehicles. With particular preference this use takes place in the context of spot repair in the automobile segment.

1. A portable apparatus having one or more infrared radiation sources, wherein said apparatus comprises an integrated accessory for generating at least one of cold and hot turbulent airflows.

2. The apparatus as claimed in claim 1, wherein the integrated accessory comprises the following components:
(a) a compressed air supply;
(b) a regulatable heating element;
(c) an incoming-air distributor system;
(d) one or more blowing nozzles; and
(e) one or more shutoff devices.

3. The apparatus as claimed in claim 2, wherein the incoming-air distributor system is a hermetically sealed incoming-air duct system mounted on the apparatus, and the blowing nozzles are mounted on outlets of the incoming-air duct system.

4. The apparatus as claimed in claim 2, wherein the blowing nozzles:
are able to operate on a Venturi principle,
can be separated from the incoming-air distributor system at least one of individually, in groups, and in their entirety, by means of shutoff devices,
are mounted such that a flow angle of emergent turbulent airflow therefrom can be adapted one of individually and in groups to the article that is to be dried,
permit stepless regulation of a flow velocity of the emergent turbulent airflow, and
the one or more infrared radiation sources are mounted alongside one another and do not impair one another in their function.

5. A method for at least partly removing solvent from coating material applied to a substrate, the method comprising using a portable apparatus having one or more infrared radiation sources, wherein the apparatus includes an integrated accessory for generating at least one of cold and hot turbulent airflows.

6. The method as claimed in claim 5, further comprising measuring a surface temperature of the coating material constantly.

7. The method as claimed in claim 6, wherein measuring the surface temperature of the coating material constantly comprises measuring the surface temperature without contact.

8. The method as claimed in claim 5, wherein the apparatus further includes one or more blowing nozzles, and wherein a flow velocity of air emerging from the one or more blowing nozzles is between 15 and 100 meters per second.

9. A method comprising:
using a portable apparatus having one or more infrared radiation sources in the production of repair finishes on vehicles, wherein the apparatus includes an integrated accessory for generating at least one of cold and hot turbulent airflows.

10. The method as claimed in claim 9, wherein using the portable apparatus comprises using the portable apparatus for spot repair of paint on motor vehicles.

11. The method as claimed in claim 8, wherein the flow velocity of the air emerging from the one or more blowing nozzles is between 15 and 50 meters per second.

12. The method as claimed in claim 11, wherein the flow velocity of the air emerging from the one or more blowing nozzles is between 15 and 30 meters per second.
